(19) United States
(12) Patent Application Publication
(10) Pub. No.: US 2014/0313620 A1
(43) Pub. Date: Oct. 23, 2014

(54) VOLTAGE PROTECTION CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: HAI-QING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/256,065

(22) Filed: Apr. 18, 2014

(30) Foreign Application Priority Data
Apr. 19, 2013 (CN) 2013101372242

(51) Int. Cl. H02H 3/20

(52) U.S. Cl. CPC H02H 3/20
USPC 361/18

(57) ABSTRACT

Voltage protection circuit connected between a current protection circuit and a load. The voltage protection circuit includes a comparator, an inverter, and an electronic switch. The current protection circuit is connected between the load and a power supply circuit for protecting the load from over-current. When an output voltage of the power supply circuit is less than a rated voltage of the load, the load receives the output voltage of the power supply circuit as normal. The power supply circuit stops outputting the output voltage to the load for protection, when the output voltage of the power supply circuit is greater than the rated voltage of the load.

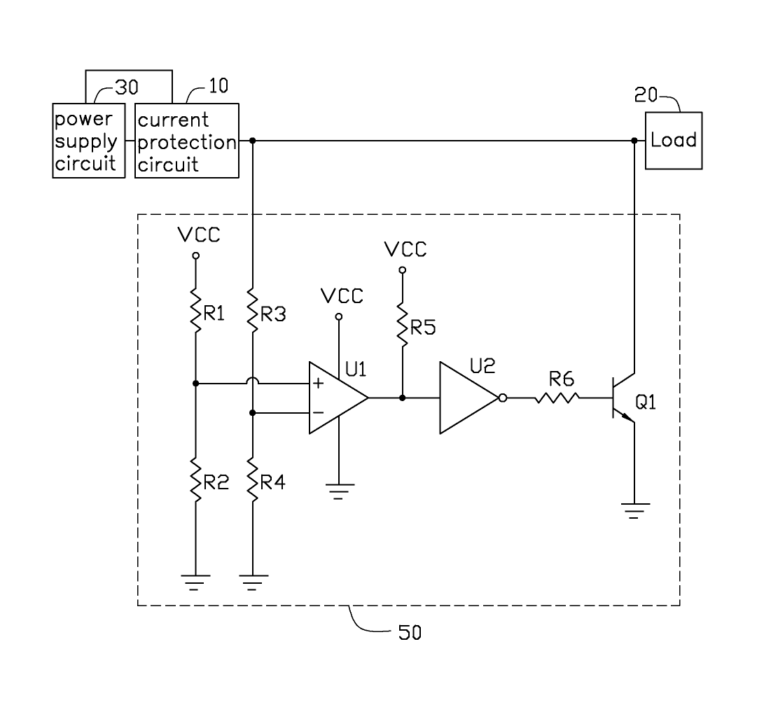

### FIELD

The present disclosure relates to a voltage protection circuit.

### BACKGROUND

Electronic devices include current protection circuits. When the current of the electronic device is over-current, a current protection circuit of the electronic device will disconnect the power source to protect the electronic device.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the presented embodiments.

The FIGURE is a circuit diagram of an embodiment of a voltage protection circuit.

### DETAILED DESCRIPTION

The disclosure, including the FIGURE, is illustrated by way of example and not by way of limitation. References to “an” or “one” embodiment in this disclosure are not necessarily to the same embodiment, and such references mean “at least one”. Although discussion herein is directed to a computer, it will be understood the principles described can be utilized with other e-devices.

The figure shows an embodiment of a voltage protection circuit 50 connected between a current protection circuit 10 and a load 20. The current protection circuit 10 can be connected between the load 20 and a power supply circuit 30 for protecting the load 20 from over-current. In the embodiment, the energy saving circuit 10 comprises a comparator U1, an inverter U2, a electronic switch Q1, and six resistors R1-R6. In the embodiment, the electronic switch Q1 includes a first terminal, a second terminal, and a third terminal.

A non-inverting input terminal of the comparator U1 is coupled to a power source VCC through the resistor R1. The non-inverting input terminal of the comparator U1 is grounded through the resistor R2. An inverting input terminal of the comparator U1 is coupled to the load 20 through the resistor R3. The inverting input terminal of the comparator U1 is grounded through the resistor R4. A power terminal of the comparator U1 is coupled to the power source VCC. A grounded terminal of the comparator U1 is grounded. An output terminal of the comparator U1 is coupled to the power source VCC through the resistor R5. The output terminal of the comparator U1 is connected to an input terminal of the inverter U2. An output terminal of the inverter U2 is connected to the first terminal of the electronic switch Q1 through the resistor R6. The second terminal of the electronic switch Q1 is connected to the load 20. The third terminal of the electronic switch Q1 is grounded.

In the embodiment, a divided voltage of a node between the resistor R1 and the resistor R2 is equal to a rated voltage of the load 20.

When a output voltage of the power supply circuit 30 is less than the rated voltage of the load 20, a first received voltage of the inverting input terminal of the comparator U1 is less than a second received voltage of the non-inverting input terminal of the comparator U1, and the output terminal of the comparator U1 outputs a high-level signal, such as logic 1. The output terminal of the inverter U2 outputs a low-level signal, such as logic 0. The low-level signal turns off the electronic switch Q1. The load 20 receives the output voltage of the power supply circuit 30 as normal.

When the output voltage of the power supply circuit 30 is greater than the rated voltage of the load 20, the first received voltage of the inverting input terminal of the comparator U1 is less than the second received voltage of the non-inverting input terminal of the comparator U1, and the output terminal of the comparator U1 outputs a low-level signal. The output terminal of the inverter U2 outputs a high-level signal. The high-level signal turns on the electronic switch Q1. Then the power supply circuit 30 is grounded through the current protection circuit 10 and the electronic switch Q1. If the current flowing through the current protection circuit 10 is too great, the current can cause the current protection circuit 10 to turn on. The current protection circuit 10 operates and outputs a return signal to the power supply circuit 30. The power supply circuit 30 stops outputting the output voltage to the load 20 for protection.

In at least one embodiment, the electronic switch Q1 is an npn bipolar junction transistor (BJT), and the first terminal, the second terminal, and the third terminal of the electronic switch Q1 are a base, a collector, and a emitter of the BJT, respectively. In at least one embodiment, the electronic switch Q1 may be an n-channel field effect transistor (FET), and or other switches having similar functions.

When an output voltage of the power supply circuit 30 is less than the rated voltage of the load 20, the load 20 receives the output voltage of the power supply circuit 30 as normal. When the output voltage of the power supply circuit 30 is greater than the rated voltage of the load 20, the power supply circuit 30 stops outputting the output voltage to the load 20 for protection.

Even though numerous characteristics and advantages of the disclosure have been set forth in the foregoing description, together with details of the structure and function of the disclosure, the disclosure is illustrative only, and changes can be made in the details given, including the matters of shape, size, and arrangement of parts within the principles of the disclosure to the full extent indicated by the broad general meaning of the terms in which the appended claims are expressed.

What is claimed is:

1. A voltage protection circuit connected between a current protection circuit and a load, the current protection circuit connected between the load and a power supply circuit for protecting the load from over-current, the voltage protection circuit comprising:
a first resistor;
a comparator comprising a non-inverting input terminal receiving a rated voltage of the load, an inverting input terminal receiving an output voltage of the power supply circuit, a power terminal being connected to a power source, a ground terminal being grounded, and an output terminal being connected to the power source through the first resistor;
an inverter comprising an input terminal being connected to the output terminal of the comparator, and an output terminal; and
an electronic switch comprising a first terminal being connected to the output terminal of the inverter, a second terminal being connected to the load, and a third terminal is grounded; wherein the second terminal of the electronic switch is connected to the third terminal of the electronic switch, in response to the first terminal of the electronic switch receiving a high-level signal; and
the second terminal of the electronic switch is disconnected from the third terminal of the electronic switch, in response to the first terminal of the electronic switch receiving a low-level signal.

2. The voltage protection circuit of claim 1, further comprising a second resistor and a third resistor, wherein the non-inverting input terminal of the comparator is connected to the power source through the second resistor, and the non-inverting input terminal of the comparator is grounded through the third resistor.

3. The voltage protection circuit of claim 2, further comprising a fourth resistor and a fifth resistor, wherein the inverting input terminal of the comparator is connected to the load through the fourth resistor, and the inverting input terminal of the comparator is grounded through the fifth resistor.

4. The voltage protection circuit of claim 3, further comprising a sixth resistor, wherein the output terminal of the inverter is connected to the first terminal of the electronic switch through the sixth resistor.

5. The voltage protection circuit of claim 1, wherein the electronic switch is a npn bipolar junction transistor (BJT), and the first terminal, the second terminal, and the third terminal of the electronic switch are a base, a collector, and an emitter of the BJT, respectively.
